(19) United States
(12) Patent Application Publication
(10) Pub. No.: US 2005/0272485 A1
(43) Pub. Date: Dec. 8, 2005

(54) Entertainment transmitting portable wireless headset unit

(76) Inventors: Sakata Estioa Boykins, Atlanta, GA (US); Dream Vicky Bailey, Atlanta, GA (US)

Correspondence Address: Sakata E. Boykins, P.O. B. 78141, Atlanta, GA, 30357, US

(21) Appl. No.: 10/960,518

(22) Filed: Jun. 7, 2004

(51) Int. Cl. H04Q 7/20

(52) U.S. Cl. 455/575.2; 455/556.1; 455/458

(57) ABSTRACT

A system facilitates two way audio transmissions in a network that includes at least one Portable Wireless Headset. The system includes a paging service provider and a server. The Portable Wireless Headset paging device generates a signal intended for a called party and transmits the signal to the paging service provider. The paging service provider forwards the signal to the server. The server translates the signal to a form of audio and sends the translated audio to the Portable Wireless Headset Unit.

### BACKGROUND-FIELD OF INVENTION

The present invention relates generally to Portable Wireless Headset paging entertainment systems and, more particularly, to systems and methods for transmitting audio to a Portable Wireless Headset paging device.

### BACKGROUND-DESCRIPTION OF PRIOR ART

Over the last several decades, pagers have become important communication device for contacting remotely-situated persons. The conventional paging systems were one-way systems. That is, the user received a paging message, usually including the paging party's telephone number or a brief message, from a central terminal, but had no way of responding to the message with the pager. If the user wanted to respond to the message in the conventional paging systems, the user needed to locate a telephone to call the Portable Wireless Headset Paging Device. In more modern conventional paging systems, pagers known as two-way pagers, have the capability of providing a response to a paging message. The response, however, typically takes the form of an acknowledgment. Other conventional systems permit the paged party to send a reply. The paging service typically stores the reply and requires the Portable Wireless Headset Paging Device to remember a confirmation number that the party can later use to determine if the paged party has left a reply to a paging message at the paging service. The Portable Wireless Headset Entertainment Transmitting Unit uses the two-way paging system. The Portable Wireless Headset sends a signal to the base unit numeric; the base unit has a telephone number that correspond with the Portable Wireless Headset. The base units reply to command signal by activating the selected entertainment unit. The reply signal is sent back to the Portable Wireless Headset in the form of audio.

As a result, a need exist for a Portable Wireless Headset Entertainment Transmitting Unit paging system that permits a user to listen to selected audio via Portable Wireless Headset. The base unit (server) can send audio signals via Portable Wireless Headset paging device from the internet, home CD players, MP3 players, or stereo players. The base unit will be allowed to reply to a paging signal by sending a reply to the Portable Wireless Headset Paging Device from the base unit connecting the stereo system, MP3 player, CD player or Internet to the Portable Wireless Headset via satallite. A need also exists for a paging system that permits a user to order music off an assigned website and listen to that music selection via Portable Wireless Headset without carrying a portable player plus CD's or MP3 player and headset. The user can listen to their entire collection via Portable Wireless Headset.

### OBJECTS AND ADVANTAGES

The present invention address these needs by permitting a user to listen to selected audio via Portable Wireless Headset, the base unit (server) can send audio signals via Portable Wireless Headset from the internet, Home CD player, MP 3 player, or stereo system. The base unit will be allowed to reply to paging signals sent by the Portable Wireless Headset to the base unit by way of assigned telephone number, initiate the command and send the audio signal back to the Portable Wireless Headset paging device.

In accordance with the purpose of the invention as embodied and broadly described herein, a system facilitates two-way paging in a network that includes at least one paging device. The system includes a paging service provider and a server. The Portable Wireless Headset paging device generates a signal intended for a base unit, transmits the signal to the paging service provider. The Portable Wireless Headset paging service provider forwards the signal to the server, the server translates the signal and sends the translated signal/audio to the Portable Wireless Headset base unit, the base unit sends the signal/audio to the Portable Wireless Headset.

In another implantation consistent with the present invention, a system includes a paging service provider and base unit. The paging service provider receives a paging signal from a Portable Wireless Headset, then delivers the paging signal to a Portable Wireless Headset paging device, which receives a reply audio through the Portable Wireless Headset paging device. The base unit receives the reply signal from the paging service provider, translates the reply to a form used by the Portable Wireless Headset, and sends the translated reply audio to the Portable Wireless Headset.

In yet another implementation consistent with the present invention, a paging apparatus includes a Portable Wireless Headset input device and a base unit processor. The Portable Wireless Headset input device generates a signal and, contact information for a Portable Wireless Headset through operation by a user of the paging apparatus. The base unit processor receives the signal and contact information from the Portable Wireless Headset input device and transmits the signal to the Portable Wireless Headset using the contact information.

### DRAWING FIGURES

FIG. 1. Is a block diagram of a Portable Wireless Headset Entertainment Transmitting Unit Portable Wireless Headset unit

FIG. 2. Is a detailed block diagram of a pager system;

FIG. 3 Is a block diagram of a paging service provider

FIG. 4. Is a block diagram of a pager to Portable Wireless Headset server

### REFERENCE NUMERALS IN DRAWINGS

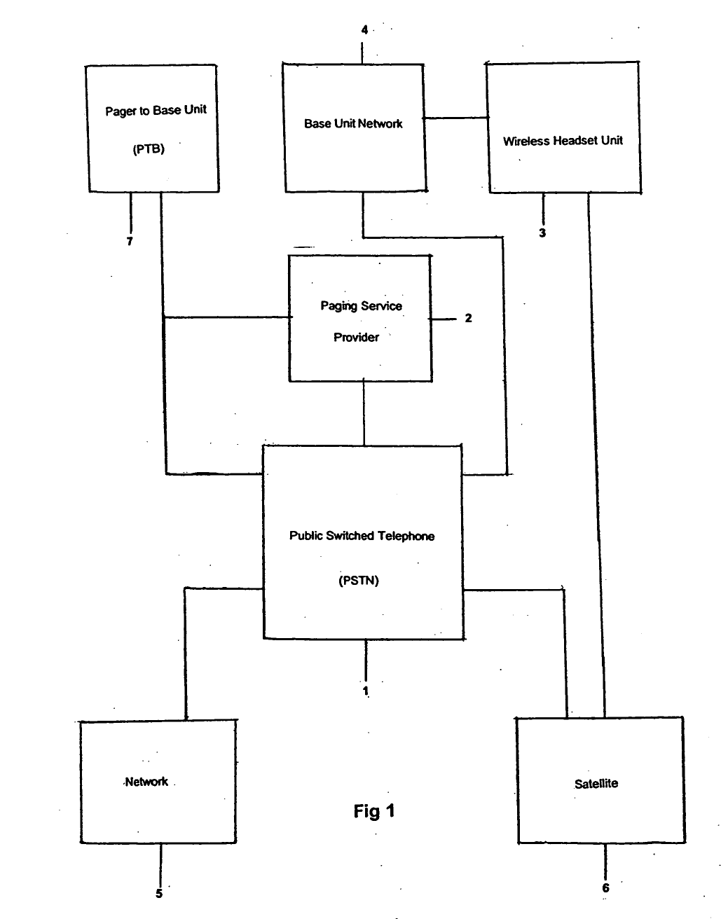

FIG. 1.

1. Public Switched Telephone Network (PSTN)

2. Paging Service Provider

3. Wireless Headset Unit

4. Base Unit

5. Network

6. Satellite

7. Pager to Base Unit (PTB)

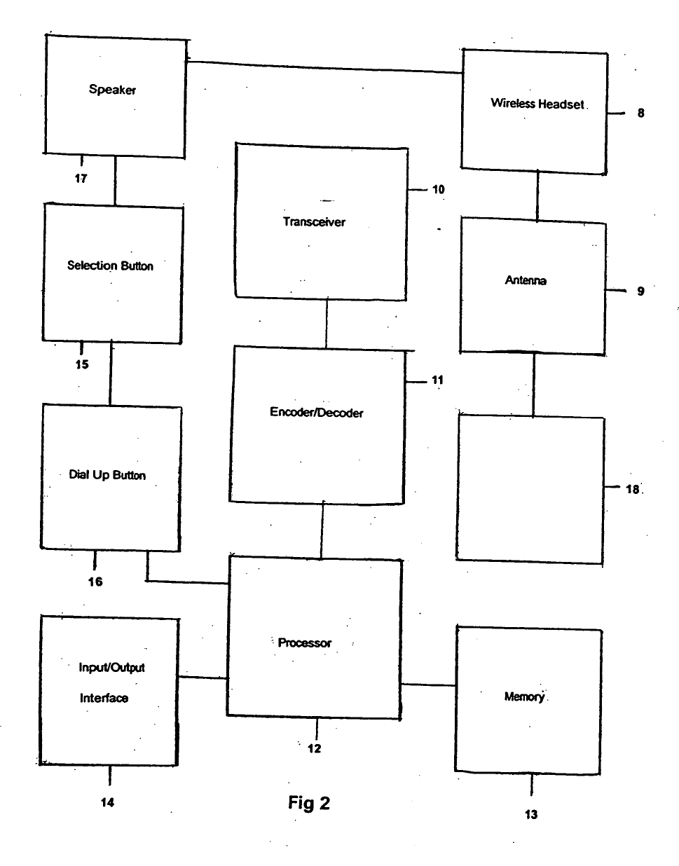

FIG. 2.

8. Wireless Headset

9. Antenna

10. Transceiver

11. Encoder/Decoder

12. Processor

13. Memory

14. Input/Output interface

15. Selection Button

16. Dial Up Button

17. Speakers

18. Omit

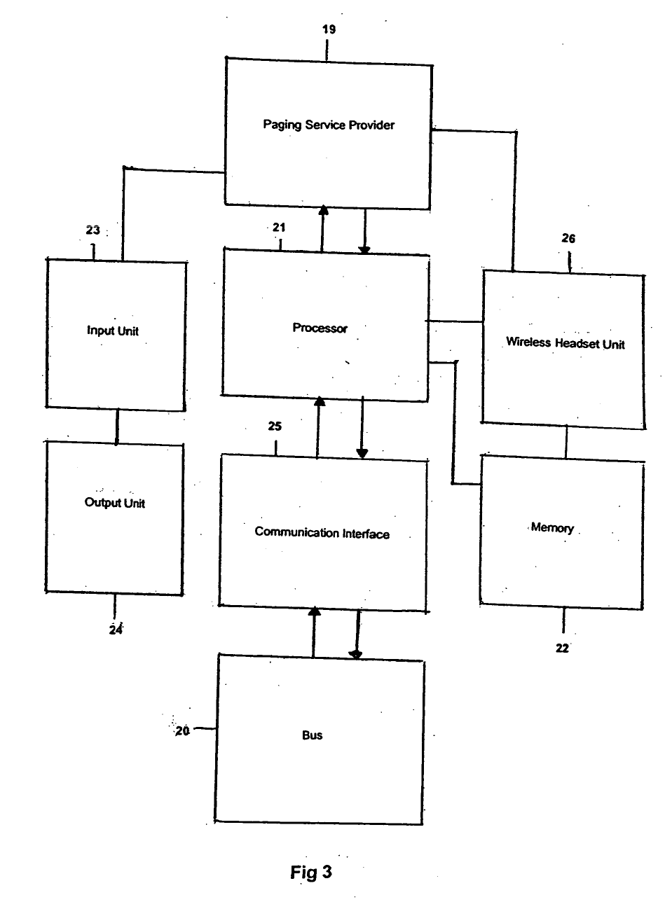

FIG. 3.

19. Paging Service Provider

20. Bus

21. Processor

22. Memory

23. Input Unit

24. Output Unit

25. Communication Interface

26. Wireless Headset Unit

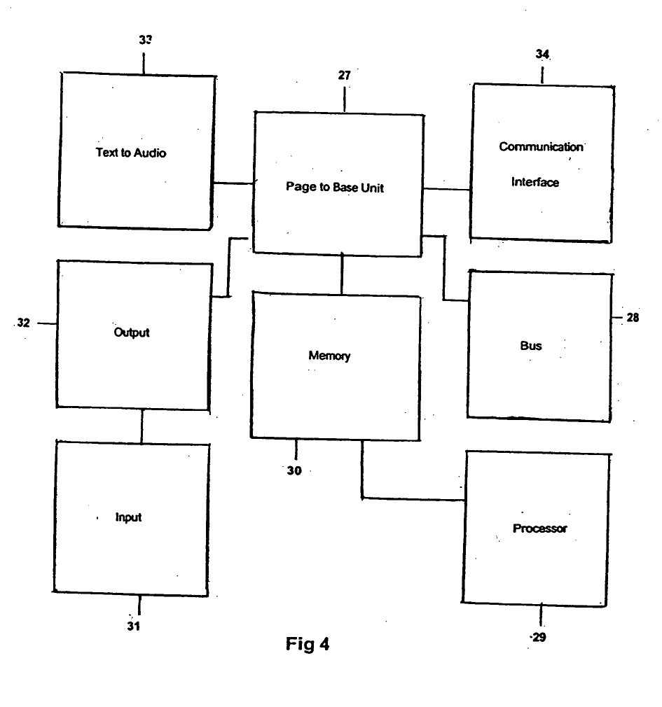

FIG. 4.

27. Page to base Unit

28. Bus

29. Processor

30. Memory

31. Input

32. Output

33. Text to Audio

34. Communication Interface

### DETAILED DESCRIPTION

The following detailed description of the invention refers to the accompanying drawings. The same reference numbers in different drawings identify the same or similar elements. Also, the following detailed description does not limit the invention. Instead, the scope of the invention is defined by the appended claims and equivalents.

System and methods consistent with the present invention provide two-way audio signal system in a low cost portable wireless device

The System

FIG. 1 is a Portable Wireless Headset Entertainment Transmitting Unit consistent with the present invention. The system Portable Wireless Headset Entertainment Transmitting Unit includes a base unit 4 the public switched telephone network (PSTN) 1, Portable Wireless Headset 3, at least one satellite 6, a paging service provider 2, a network 5, and a pager to base unit (PTB) server 7. The base unit 4 may include any conventional device that can place and receive telephone calls over PSTN 1.

The Portable Wireless Headset 3 is a two-way Portable Wireless Headset paging device. FIG. 2. is a diagram of the Portable Wireless Headset 3, includes an antenna 9, a transceiver 10, an encoder/decoder 11, a processor 12, a memory 13, an input/output 14, (I/O) interface, dial up button 16, selection button 15, and speakers 17. The transceiver 10 may include a conventional transceiver that facilitates the transmitting and receiving of information by the antenna 09.

The encoder/decoder 11 may include hardware and/or software that encodes the information transmitted by the transceiver 10 and then decode the information received by the transceiver 10. The processor 12 may include any conventional processor or microprocessor that executes instructions to control the operation of the Portable Wireless Headset 3. The memory 13 may include static memory, such as a read only memory (ROM), dynamic memory, such as a random access memory (RAM) or any combination of the two for storage of number. Among other things, the memory 13 stores instructions and data used by the processor 12. The I/O interface 14 connects the processor 12 to input and output devices, such as out board speakers. The service buttons 15-16 may include a selection button 15 and dial up button 16 to permit a user to control the operation of the Portable Wireless Headset and receives audio signals via the headset speakers 17 to provide audio to the user. The beep notifies the user of an incoming signal by outputting an audible tone through the speakers 17 to alert of advertising or music previews.

Returning to FIG. 1, the Portable Wireless Headset 3 communicates with satellites 6 via a wireless communication stream. The satellite 6 may include any combination of stationary and/or orbiting satellites capable of communicating with the Portable Wireless Headset 03. The satellite 6 relays signals between the Portable Wireless Headset 3 and the paging service provider 2. The paging service provider 2 controls the paging service, including the receipt and delivery of paging signals.

FIG. 3 is a diagram of the paging service provider 19; the paging service provider 19 includes a bus 20, a processor 21, a memory 22, an input unit 23, an output unit 24, and a communication interface 25. The bus 20 permits communication among the components of the paging service provider 19. The processor 21 may be any type of conventional processor or microprocessor that interprets and executes instructions. The memory 22 may be a RAM or other storage device that stores static information and instructions for use by the processor 22, and/or some other type of magnetic or optical recording medium and its corresponding drive.

The input unit 23 may include any conventional mechanism that permits an operator to input information into the paging service provider 10, such as voice recognition and or biometric mechanisms, etc. the output unit 24 may include any conventional mechanism that outputs information to the operator. Including a display, a printer. Speaker, the communication interface 25 may include any transceiver like mechanism that enables the paging service provider 19 to communicate with other devices and/or systems.

Returning to FIG. 1, the paging service provider 2 connects to a network 5. The network 5 may include the internet, an intranet, a local area network (LAN), a wide area network (WAN), etc. the network 5 facilitates communication between the paging service provider 2 and the PTB server 7. The PTB server 7 facilitates the transmission of signals originating at the Portable Wireless Headset 3 to a device connected to the PSTN 1. Such as base unit.

As illustrated in FIG. 1, the PTB server 7 may communicate with the base unit by initiating a telephone call over the PSTN 1. In an alternative implementation consistent with the present invention, the PTB server 7 communicates with the base unit by initialing a call through network 5. In this case, the network 5 routes the call to the PSTN 1 via a conventional gateway. In another alternative implementation consistent with the present invention, the PTB server 7 communicates with the base unit by initiating a call through a network 5. The network 5 may include the internet, an intranet, a LAN, a WAN or an equivalent data network. In this case, the network 5 routes the call to the PSTN 1 via conventional gateways.

FIG. 4 is a diagram of PTB server 27. The PTB server 27 includes a bus 28, a processor 29, a memory 30, an input unit 31, an output unit 32, a text to audio converter 33, and a communication interface 34. The bus 28 permits communication among the components of the PTB server 27. The processor 29 may be any type of conventional processor or microprocessor that interprets and executes instructions. The memory 30 may be a RAM or other storage device that stores information and instructions to be executed by the processor 29; a ROM or other type of static storage device that stores static information and instructions for use by the processor 29; and/or hard drive or some other type of magnetic or optical recording medium and its corresponding drive.

The input unit 31 may include conventional mechanism that permits an operator to input information into the PTB server 27; the output unit 32 may include any conventional mechanism that outputs information to the operator including speakers. The text to audio converter 33 may use any conventional translation algorithm to perform the conversion play of music.

System Processing

System processing for replying to a Portable Wireless Headset processing in a manner consistent with the present invention. Processing begins when a Portable Wireless Headset using, for example a base unit initiates a page by calling a telephone number associated with the Portable Wireless Headset 3. By calling the telephone number, the telephone number base unit 4 connects the paging service provider 2 via PSTN 1. The Portable Wireless Headset then sends a page signal to the paging service provider 2. The Portable Wireless Headset also transmits a telephone number to which the Portable Wireless Headset may send a reply. The paging service provider 2 receives the signal and the telephone number from the Portable Wireless Headset Paging Device. The paging service provider 2 then encodes the signal and telephone number into a paging signal and transmits the signal to the Base Unit via satellite 6; the Base Unit receives the paging signal and notifies the Portable Wireless Headset of its receipt. The Portable Wireless Headset 3 may notify the pages party by emitting an audible tone. Upon notifying the Portable Wireless Headset, the encoder/decoder 11 within the Portable Wireless Headset 3 decodes the signal and displays the decoded signal audio to the Portable Wireless Headset. If the Portable Wireless Headset paging device decides to reply to the signal, the Portable Wireless Headset paging unit inputs the reply using the selection buttons 15.

The Base Unit 4 receives the reply from the Portable Wireless Headset encodes it along with the telephone number of the portable wireless headset and transmits it to the paging service provider 2 via satellite 6. The paging service provider 2 decodes the encoded signal and forwards the reply and telephone number to the PTB server 7 via the network 5. The PTB server 7 receives the reply and telephone number and converts the reply from text to digitized audio. The PTB server 7 then uses the telephone number to place a call to the portable wireless headset over the PSTN 1, either directly or via network 5.

Once the connection has been established, the PTB server 1 sends the digitized audio reply to the portable wireless headset. The PTB server 1 might be set up to retry the call several times if the telephone numbers of the Portable Wireless Headset respond. System Processing For Initiating a Signal

Processing for initiating a signal in a manner consistent with the present invention. Processing begins when a user of the Portable Wireless Headset 3 decides to dial up to the base unit. The user inputs a signal into the Portable Wireless Headset 3 using the selection button 15; the signal is text signal that the user may generate using the selection button 15. The signal includes contact information, such as the telephone number of the Portable Wireless Headset.

The Portable Wireless Headset 3 receives the text signal, encodes it, and transmits it to the paging service provider 2 via satellites 6. The paging service provider 2 decodes the signal and forwards it to the PTB server 7 via network 5. The PTB server 7 receives the signal and converts it from text form to digitized audio. The PTB server 7 then uses the telephone number input 14 to place a call to the Portable Wireless Headset for the PSTN 1, either directly or via network 5. Once the connection has been established the PTB server 7 sends the digitized audio signal to the Portable Wireless Headset. The PTB server 7 might be set up to retry the call several times if the telephone number does not answer.

Summary, Ramifications, and Scope

The present invention permits Portable Wireless Headset operators to not only receive signals using the Portable Wireless Headset Portable Wireless Headset Entertainment Transmitting Unit, but to reply to the signal and initiate signal using only the Portable Wireless Headset. These systems and methods provide a very low cost alternative to MP3 players, CD players, and Internet downloads and other forms of portable entertainment communication devices.

The foregoing description of preferred embodiments of the present invention provides illustration and description, but not intended to be exhaustive or to limit the invention to the precise form disclosed. Modifications and variations are possible in light of the above teachings or may be acquired from practice of the invention. The scope of the invention is defined by the claims and their equivalents. The PTB server has been described as including a text and audio converter. Additionally, or alternatively, the PTB server may include other converters for sending signals to different types of devices.

Having described several implementations of the invention, it will be apparent that various alterations, modifications and improvements will be readily occur to those skilled in the art of product engineering. Such alterations, modifications and improvements, throughout describe above, are none the less intended and implied to be within the spirit and scope of the invention. The foregoing discussion is intended to be illustrative only.

1. A system that communicates with a Portable Wireless Headset paging device, comprising;
A. A paging service provider;
B. Receive a paging signal and a telephone number from a Portable Wireless Headset Paging Device using a base unit paging device.
C. Encode the paging audio and the telephone number into a paging audio signal,
E. Delivers the paging signal audio to the Portable Wireless Headset paging device,
F. Receive an encoded reply signal from the Portable Wireless Headset paging device, the encoded reply signal including numeric reply and the telephone number from the Portable Wireless Headset Paging Device, and
G. Decode the encoded reply signal to extract the command reply and the telephone number; and;
H. A server connected to the paging service provider and configured to:
I. Receive the command reply and the telephone number from the paging service provider,
J. Translate the command reply to an audio signal, and
K. Place a call to the base unit of the Portable Wireless Headset Paging Device to send the audio signal to the Portable Wireless Headset Paging Device using the telephone number,

2. The system of claim 1, wherein, the server includes:
A. A text to audio converter configured to translate the audio reply to a digitized audio signal for delivery to the telephone device.

3. A system for communicating with a Portable Wireless Headset paging device, comprising:
A. Means for receiving a paging audio and a telephone number from a Portable Wireless Headset Paging Device using a base unit device;
B. Means for delivering the paging audio and the telephone number to the Portable Wireless Headset paging device,
C. Means for receiving a reply signal from the Portable Wireless Headset paging device, the reply signal including audio reply and the telephone number;
D. Means for translating the audio reply to audio; and
I. Means for sending the audio reply to the base unit device of the Portable Wireless Headset Paging Device using the telephone number.

4. A method for communicating with a Portable Wireless Headset paging device in a network including a paging service provider and a server, the method comprising;
A. Receiving, at the paging service provider, paging signal and a telephone number from a Portable Wireless Headset Paging Device using a base unit,
B. Delivering the paging signal and the telephone number to the Portable Wireless Headset paging device,
C. Transmitting the reply signal and the telephone number to the server,
D. Translating, at the server, the reply signal to a audio signal; and
E. Sending the audio signal to the base unit of the Portable Wireless Headset Paging Device using a telephone number then to the Portable Wireless Paging Device.

5. The method of claim 4, further comprising;
A. Encoding the paging signal and the telephone number into a paging audio.

6. The method of claim 5, wherein, the delivering the paging signal and the telephone number includes:
A. Transmitting the paging audio to the Portable Wireless Headset paging device.

7. The method of claim 4, wherein the receiving a reply signal and the telephone number includes:
A. Receiving an encoded reply signal from the Portable Wireless Headset paging device and
B. Decoding the encoded reply signal to extract the reply audio and the telephone Number.
